(19) United States
(12) Patent Application Publication
(10) Pub. No.: US 2025/0101605 A1
(43) Pub. Date: Mar. 27, 2025

(54) ELECTROLYTE FOR ELECTROCHEMICAL NITROGEN REDUCTION REACTION AND METHOD FOR ELECTROCHEMICALLY PREPARING AMMONIA USING THE SAME

(71) Applicant: SEOUL NATIONAL UNIVERSITY R&DB FOUNDATION, Seoul (KR)

(72) Inventors: Yun Jeong HWANG, Seoul (KR); Dongwoo SHIN, Seoul (KR); Yeongbae JEON, Seoul (KR)

(21) Appl. No.: 18/799,181

(22) Filed: Aug. 9, 2024

(30) Foreign Application Priority Data
Sep. 22, 2023 (KR) 10-2023-0126792

(51) Int. Cl. C25B 1/27; C25B 11/042

(52) U.S. Cl. CPC C25B 1/27; C25B 11/042

(57) ABSTRACT

An electrolyte for an electrochemical nitrogen reduction reaction and a method for electrochemically preparing ammonia using the same are provided. The electrolyte includes a first lithium salt including at least one selected from the group consisting of a fluoroborate-based lithium salt, a fluorophosphate-based lithium salt, a fluoroarcenate-based lithium salt, and a fluorosulfonylimide-based lithium salt, a second lithium salt different from the first lithium salt, and an organic solvent.

### CROSS-REFERENCE TO RELATED APPLICATION

This application claims the benefit of priority to Korean Patent Application No. 10-2023-0126792, filed in the Korean Intellectual Property Office on Sep. 22, 2023, the entire contents of which are incorporated herein by reference.

### TECHNICAL FIELD

The present disclosure relates to an electrolyte for an electrochemical nitrogen reduction reaction and a method for electrochemically preparing ammonia using the same.

### BACKGROUND

Ammonia (NH₃) may be mainly used as a source material for various chemical industries and a solvent for an ionic substance. In addition, ammonia has been spotlighted as a storage way and a transfer way to solve the issue of regional ubiquity and intermittence of renewable energy because ammonia is much easier to be liquefied rather than hydrogen.

Conventionally, the Harbor-Bosch process was used as the most common way for synthesizing ammonia. The Harbor-Bosch process is a process for synthesizing two ammonia molecules by binding one nitrogen molecule and three hydrogen molecules as expressed in following chemical equation 1 under the presence of an iron or ruthenium catalyst. However, the Harbor-Bosch process shows the lower ammonia synthesis yield ranging from about 10% to 20% and produces a larger amount of carbon dioxide produced from the fossil fuel used in the process for synthesizing ammonia.

$${N}_{2} + 3 {H}_{2} -> 2 {NH}_{3} + 92.2 kJ \qquad 〈 Chemical Equation 1 〉$$

Therefore, to overcome the limitations of the above Harbor-Bosh process, there has been suggested a method for synthesizing ammonia through an electrochemical nitrogen reduction reaction.

Meanwhile, the electrochemical nitrogen reduction reaction using an aqueous electrolyte employing water and nitrogen as a source material goes through the same process as the following chemical equation 2. The final product obtained through the above process contains only ammonia and oxygen. Accordingly, the final product is eco-friendly.

$$Oxidation electrode reaction : 3 {H}_{2} O \to 6 H + 3 / 2 {O}_{2} + 6 e - \qquad 〈 Chemical Equation 2 〉$$

$$Reduction electrode reaction : {N}_{2} + 6 {H}^{+} + 6 {e}^{-} \to 2 {NH}_{3}$$

However, in the aqueous electrochemical nitrogen reduction reaction, a side reaction to produce hydrogen is mainly made instead of the nitrogen reduction reaction at a reduction electrode. Accordingly, the current efficiency of less than 1% appears. Accordingly, recently, studies and researches have been performed on a method for synthesizing ammonia through a non-aqueous electrochemical nitrogen reduction reaction.

However, when an electrode area is widened even when a non-aqueous electrochemical nitrogen reduction reaction is used, the reaction selectivity for ammonia is lowered, and the voltage stability may be decreased when the reaction is performed for a longer time.

Therefore, there is a need for a non-aqueous electrochemical nitrogen reduction reaction with increased stability while increasing reaction selectivity for ammonia and a method of synthesizing ammonia using it.

### SUMMARY

The present disclosure has been made to solve the above-mentioned problems occurring in the prior art while advantages achieved by the prior art are maintained intact.

An aspect of the present disclosure provides an electrolyte for an electrochemical nitrogen reduction reaction and a method for electrochemically preparing ammonia using the same, capable of providing fluorine ions onto an electrode surface such that the reaction selectivity for the ammonia is increased, and the stability is improved.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an electrolyte for an electrochemical nitrogen reduction reaction, may include a first lithium salt including at least one selected from the group consisting of a fluoroborate-based lithium salt, a fluorophosphate-based lithium salt, a fluoroarcenate-based lithium salt, and a fluorosulfonylimide-based lithium salt, a second lithium salt different from the first lithium salt, and an organic solvent.

According to an aspect of the present disclosure, a method for electrochemically preparing ammonia, may include synthesizing the ammonia through an electrochemical nitrogen reduction reaction from nitrogen (N₂), by applying a current a reduction electrode under presence of the electrolyte for the electrochemical nitrogen reduction reaction.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating a reaction cycle using an electrolyte for an electrochemical nitrogen reduction reaction according to an embodiment of the present disclosure;

FIG. 2 is a schematic view illustrating an electrode surface including a lithium fluoride layer;

FIG. 3A is an XPS analysis graph of an electrode surface according to Comparative Example 1, and FIG. 3B is an XPS analysis graph of an electrode surface according to Embodiment 2;

FIG. 4 is a 3D cubic image obtained by analyzing an electrode surface according to Embodiment 2 through time of flight-secondary ion mass spectroscopy (TOF-SIMS); and

FIG. 5 is a graph illustrating the change in the potential of a reduction electrode according to a reaction time.

### DETAILED DESCRIPTION

Hereinafter, an electrolyte for an electrochemical nitrogen reduction reaction and a method for electrochemically preparing ammonia using the same will be described in detail so that those skilled in the art may easily reproduce the electrolyte for the electrochemical nitrogen reduction reaction and the method for electrochemically preparing ammonia using the same.

The electrolyte for the electrochemical nitrogen reduction reaction according to an embodiment of the present disclosure may include a first lithium salt containing at least one selected from the group consisting of a fluoroborate-based lithium salt, a fluorophosphate-based lithium salt, a fluoroarcenate-based lithium salt, and a fluorosulfonylimide-based lithium salt, a second lithium salt different from the first lithium salt, and an organic solvent.

In general, the electrochemical nitrogen reduction reaction has a series of processes in which lithium reacts with nitrogen to forma lithium nitride as expressed in following chemical equation 3, and the lithium nitride reacts with hydrogen ions to synthesize ammonia as expressed in the following chemical equation 4.

$$xLi + {N}_{2} \to {Li}_{x} N \qquad 〈 Chemical equation 3 〉$$

$${Li}_{x} N + 3 {H}^{+} \to {NH}_{3} + {xLi}^{+} \qquad 〈 Chemical equation 4 〉$$

According to the present disclosure, to increase reaction selectivity for ammonia, fluorine ions are provided on an electrode surface from the first lithium salt, thereby forming LiF—LiₓN.

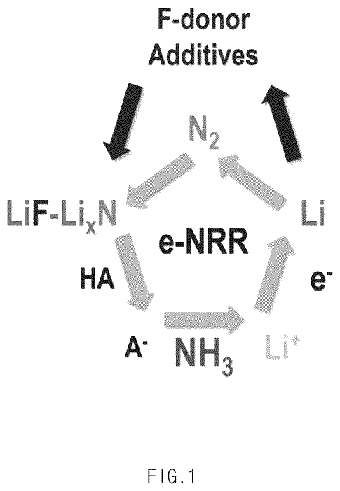

FIG. 1 is a schematic view illustrating a reaction cycle using an electrolyte for an electrochemical nitrogen reduction reaction according to an embodiment of the present disclosure.

Referring to FIG. 1, it may be recognized that fluorine ions are provided on an electrode surface from the first lithium salt, thereby forming LiF—LiₓN, when lithium and nitrogen react with each other to form lithium nitride.

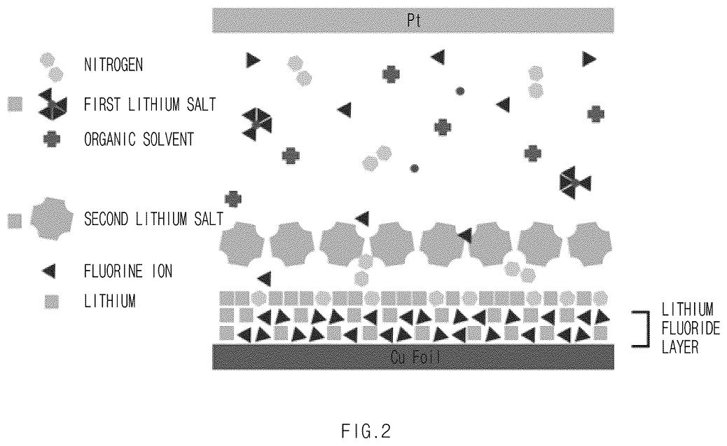

FIG. 2 is a schematic view illustrating an electrode surface including the lithium fluoride layer.

Referring to FIG. 2, the first lithium salt, the second lithium salt, and the organic solvent are contained in the electrolyte, the fluorine ions are provided on a surface of the reduction electrode from the first lithium salt to form a lithium fluoride layer, and lithium nitride (LiₓN) is produced at the lithium fluoride layer, thereby improving reaction selectivity for ammonia.

The first lithium salt may include at least one selected from the group consisting of the fluoroborate-based lithium salt, the fluorophosphate-based lithium salt, the fluoroarcenate-based lithium salt, and the fluorosulfonylimide-based lithium salt to effectively provide the fluorine ions on the electrode surface. In other words, the first lithium salt may provide fluorine ions more effectively on the electrode surface because a fluorine atom group is bonded to atoms such as boron, phosphorus, arsenic, and sulfur, instead of directly being bonded to a carbon atom.

Specifically, the fluoroborate-based lithium salt may be a lithium difluoro(oxalato)borate (LiFOB; LiBF₄-xHx) or lithium bis(2,2-difluoro-1,3-dioxolane-4,5-bis(oxalato)borate) (LiDFOB). The fluorophosphate-based lithium salt may be LiPF_{6-y}H_{y}. The fluoroarcenate-based lithium salt may be LiAsF_{6-y}H_{y}. The fluorosulfonylimide-based lithium may be a lithium salt including an N(SO₂F) group and/or an N(SO₂F)₂ group, and more specifically, Lithium bis(fluorosulfonyl)imide (LiFSI) or a derivative (e.g., Li(+) F—SO₂—N⁽⁻⁾SO₂—R (where R is an alkyl group or a fluoroalkyl group having 1 to 6 carbon atoms) thereof. In this case, ‘x’ denotes a real number raging from ‘0’ to ‘3’, and ‘y’ and ‘z’ denote each independently a real number ranging from ‘0’ to ‘5’.

More specifically, the first lithium salt may include at least one selected from the group consisting of LiBF₄, LiPF₆, and LiAsF₆.

The first lithium salt may be contained in a content ranging from 0.0001 wt % to 10 wt %, preferably 0.01 wt % to 1.0 wt %, more preferably 0.1 wt % to 0.5 wt %, and more preferably 0.2 wt % to 0.4 wt %.

As the content of the first lithium salt is controlled within the above range, the reaction selectivity for ammonia may be effectively increased, thereby improving the ammonia synthesis yield. However, when the content of the first lithium salt is low, the degree of improvement in the ammonia synthesis yield may be somewhat low. When the content of the first lithium salt is excessively high, the lithium fluoride layer formed on the electrode surface may become thick, so the electrode resistance is increased, thereby slightly lowering the ammonia synthesis yield.

The organic solvent may include at least one selected from the group consisting of propylene carbonate, ethylene carbonate, dimethyl carbonate, 1,3-dioxolane, dimethoxyethane, tetrahydrofuran, dimethylformamide, acetonitrile, and N-methylpyrrolidone.

Furthermore, the organic solvent, which is a medium to provide protons, may further include at least one selected from the group consisting of ethanol, 1-propanol, 2-methyl-1-propanol, tert-butyl alcohol, 2-butanol, 2-ethyl-1-butanol, 1-pentanol, 1-hexanol, 1-heptanol, 1-nonanol, benzyl alcohol, phenol, 1-phenylethanol, 2-phenylethanol, 2-chloroethanol, 2,2,2-trifluoroethanol, hexafluoro 2-propanol, 1,3-butanediol, glycerol, triethylene glycol, 1,5-pentanediol, acetic acid, hexane, alkyl alcohol, 2-methoxyethanol, 1-propanediol, methanol, cyclohexanol, 3-butene-1-ol, 2-propanol, 1-butanol, and 3-methyl-1-butanol.

The second lithium salt may include at least one selected from the group consisting of lithium perchlorate, lithium dithionate, lithium sulfate, lithium bromide, lithium chloride, and lithium bis(oxalato)borate.

Hereinafter, the method for electrochemically ammonia according to another embodiment of the present disclosure will be described in detail.

The method for electrochemically preparing ammonia according to an embodiment of the present disclosure may include a step of synthesizing ammonia from nitrogen (N₂) through the electrochemical reduction reaction, by applying the current to a reduction electrode under the presence of the electrolyte for the electrochemical nitrogen reduction reaction.

Specifically, when the current is applied to the reduction electrode under the presence of the electrolyte for the electrochemical nitrogen reduction reaction above, electrons originate from an oxidation electrode, and flow to the reduction electrode to reduce lithium ions, which are contained in the electrolyte, on the surface of the reduction electrode. As described above, the reduced lithium may react with nitrogen to form lithium nitride, the lithium nitride may react with fluorine ions provided on the electrode surface from the first lithium salt to form LiF—LiₓN, and then LiF—LiₓN may react with hydrogen ions to synthesize ammonia.

In this case, as the current is applied to the reduction electrode, a layer including lithium fluoride containing fluorine ions (F—) provided from the first lithium salt may be formed on the surface of the reduction electrode. The formed layer including lithium fluoride is a main factor for improving the reaction selectivity for ammonia.

The step for applying the current to the reduction electrode may include applying a constant current ranging −1 mA/cm² to −100 mA/cm² for 15 minutes to 12 hours, preferably applying a constant current ranging −10 mA/cm² to −80 mA/cm² for 1 to 5 hours, and more preferably, applying a constant current ranging −40 mA/cm² to −60 mA/cm² for 1 to 4 hours.

The electrochemical nitrogen reduction reaction may be stably performed while synthesizing ammonia at a high yield rate by applying the current within the above range for the time to apply the current. However, the lower current or the shorter time may decrease the ammonia synthesis yield, and the higher current or the longer time may decrease the reaction stability.

Meanwhile, the current may be applied in various forms such as a constant voltage, a step current, a step voltage, an alternating current (AC) current, or an AC voltage, in addition to the constant current.

The reduction electrode may include at least one selected from the group consisting of gold (Au), silver (Ag), copper (Cu), platinum (Pt), zinc (Zn), iron (Fe), titanium (Ti), tin (Sn), indium (In), bismuth (Bi), samarium (Sm), nickel (Ni), molybdenum (Mo), cobalt (Co), stainless steel, graphene, carbon nanotubes, and fullerene. In addition, for example, the reduction electrode may be utilized in the form of a thin film, but the present disclosure is not limited thereto. For example, the reduction electrode may be utilized in various forms such as a mesh, a gas diffusion electrode, a wire, or an electrodeposit electrode.

As described above, the nitrogen (N₂) may react with lithium provided from the first lithium salt and the second lithium salt to form lithium nitride (LiₓN). In this case, ‘x’ which is the subscript of Li denotes a molar ratio of Li element.

The lithium nitride (LiₓN) may bind with a layer including the lithium fluoride, and LiF—LiₓN, which is obtained through the binding with the layer including the lithium fluoride, may react with hydrogen ions (H⁺) to synthesize ammonia (NH₃). In this case, LiF—LiₓN which is obtained through the binding with the layer including the lithium fluoride may improve reaction selectivity for ammonia, thereby improving ammonia synthesis yield.

### EMBODIMENTS

Hereinafter, the present disclosure will be described in more detail with reference to embodiments. However, embodiments are provided only for the illustrative purpose, and the present disclosure is not limited to the embodiments.

### Embodiment 1—Preparation 1 of Electrolyte for Electrochemical Nitrogen Reduction Reaction

The electrolyte for the electrochemical nitrogen reduction reaction using 0.1% by weight (wt %) of LiBF₄ (Sigma Aldrich) serving as the first lithium salt, 2M of lithium bis (trifluoromethane)sulfonylimide lithium (bis (Wellcos Corporation) serving as the second lithium salt, and tetrahydrofuran containing 1 wt % of ethanol (Wellcos Corporation) serving as the organic solvent was prepared in a glove box.

### Embodiment 2—Preparation 2 of Electrolyte for Electrochemical Nitrogen Reduction Reaction

The electrolyte was prepared in the same manner as in Embodiment 1, except for the use of 0.3 wt % of LiBF₄ serving as the first lithium salt.

### Embodiment 3—Preparation 3 of Electrolyte for Electrochemical Nitrogen Reduction Reaction

The electrolyte was prepared in the same manner as in Embodiment 1, except for the use of 0.5 wt % of LiBF₄ serving as the first lithium salt.

### Embodiment 4—Preparation 4 of Electrolyte for Electrochemical Nitrogen Reduction Reaction

The electrolyte was prepared in the same manner as in Embodiment 1, except for the use of 0.1 wt % of LiPF₆ serving as the first lithium salt.

### Embodiment 5—Preparation 5 of Electrolyte for Electrochemical Nitrogen Reduction Reaction

The electrolyte was prepared in the same manner as in Embodiment 1, except for the use of 0.3 wt % of LiPF₆ serving as the first lithium salt.

### Comparative Example 1—Preparation 6 of Electrolyte for Electrochemical Nitrogen Reduction Reaction

The electrolyte was prepared in the same manner as in Embodiment 1, except that the first lithium salt is not contained.

### Comparative Example 2—Preparation 7 of Electrolyte for Electrochemical Nitrogen Reduction Reaction

The electrolyte was prepared in the same manner as in Embodiment 1, except for the use of 0.1 wt % of LiClO₄ serving as the first lithium salt.

### Comparative Example 3—Preparation 8 of Electrolyte for Electrochemical Nitrogen Reduction Reaction

The electrolyte was prepared in the same manner as in Embodiment 1, except for the use of 0.3 wt % of LiClO₄ serving as the first lithium salt.

### Comparative Example 4—Preparation 9 of Electrolyte for Electrochemical Nitrogen Reduction Reaction

The electrolyte was prepared in the same manner as in Embodiment 1, except for the use of 0.1 wt % of LiBOB serving as the first lithium salt.

### Embodiment 6—Electrochemical Preparation 1 of Ammonia

A three-electrode system was prepared by using a single compartment electrochemical cell formed of stainless steel including the electrolyte according to Embodiment 1, a Pt gauze serving as a counter electrode, a Pt wire pseudo electrode serving as a reference electrode, and a copper foil in size of 2 cm² serving as the reduction electrode.

The electrochemical cell was filled with N₂ at 20 atmospheres, and a constant current of −55 mA/cm² was applied for one hour to prepare ammonia.

### Embodiment 7—Electrochemical Preparation 2 of Ammonia

Ammonia was prepared in the same manner as in Embodiment 6, except for the use of the electrolyte prepared according to Embodiment 2.

### Embodiment 8—Electrochemical Preparation 3 of Ammonia

Ammonia was prepared in the same manner as in Embodiment 6, except for the use of the electrolyte prepared according to Embodiment 3.

### Embodiment 9—Electrochemical Preparation 4 of Ammonia

Ammonia was prepared in the same manner as in Embodiment 6, except for the use of the electrolyte prepared according to Embodiment 4.

### Embodiment 10—Electrochemical Preparation 5 of Ammonia

Ammonia was prepared in the same manner as in Embodiment 6, except for the use of the electrolyte prepared according to Embodiment 5.

### Comparative Example 5—Electrochemical Preparation 6 of Ammonia

Ammonia was prepared in the same manner as in Embodiment 6, except for the use of the electrolyte prepared according to Comparative example 1.

### Comparative Example 6—Electrochemical Preparation 7 of Ammonia

Ammonia was prepared in the same manner as in Embodiment 6, except for the electrolyte prepared according to Comparative example 2.

### Comparative Example 7—Electrochemical Preparation 7 of Ammonia

Ammonia was prepared in the same manner as in Embodiment 6, except for the use of the electrolyte prepared according to Comparative example 3.

### Comparative Example 8—Electrochemical Preparation 8 of Ammonia

Ammonia was prepared in the same manner as in Embodiment 6, except for the use of the electrolyte prepared according to Comparative example 4.

### Embodiment 11—Electrochemical Preparation 9 of Ammonia

Ammonia was prepared in the same manner as in Embodiment 6, except that the electrolyte prepared according to Embodiment 1 was utilized and, a constant current of −55 mA/cm² was applied for four hours.

### Embodiment 12—Electrochemical Preparation 10 of Ammonia

Ammonia was prepared in the same manner as in Embodiment 6, except that the electrolyte prepared according to Embodiment 2 was utilized and, a constant current of −55 mA/cm² was applied for four hours.

### Comparative Example 9—Electrochemical Preparation 11 of Ammonia

Ammonia was prepared in the same manner as in Embodiment 6, except that the electrolyte prepared according to Comparative example 1 was utilized and, a constant current of −55 mA/cm² was applied for four hours.

### Experimental Example 1—Experiment to Determine Whether the Lithium Fluoride Layer is Formed

Whether the lithium fluoride layer was formed was determined by analyzing an element of ‘F’ on the electrode surface according to Comparative Example 1 or Embodiment 2 through an X-ray Photoelectron Spectroscopy (XPS; thermo Scientific Nexa G2) device.

Specifically, the XPS device operated by Al-Kα X-ray source radiation in ultra-high vacuum (10⁻⁸ to 10⁻⁹ mbar), the X-ray beam size was 200 μm, the depth profile was operated by 3 keV Ar⁺ sputtering, and the sputtering speed was performed at Ta₂O₅ of 1.92 nm·sec⁻¹. In this case, the electrode surface using Comparative Example 1 was etched at a level of 20 for 10 seconds, and the electrode surface using Embodiment 2 was etched at a level of 80 for 60 seconds.

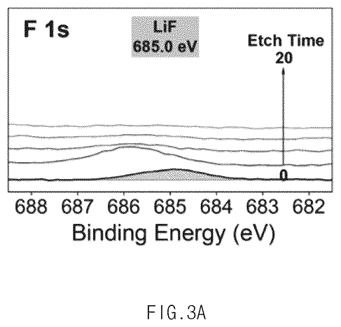

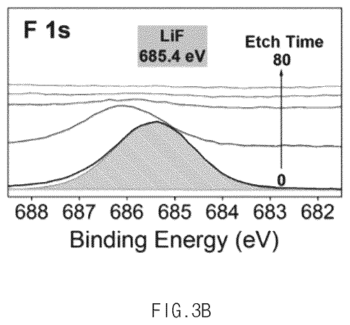

FIG. 3A is an XPS analysis graph of an electrode surface according to Comparative Example 1, and FIG. 3B is an XPS analysis graph of an electrode surface according to Embodiment 2.

Referring to FIGS. 3A and 3B, it was recognized that THE lithium fluoride layer was formed with respect to the electrode surface according to Embodiment 2 using 0.3 wt % of LiBF₄ as the first lithium salt.

Additionally, it was determined whether the lithium fluoride layer was formed, with respect to the electrode according to Embodiment 2, by utilizing a Time of Flight-Secondary Ion Mass Spectroscopy (TOF-SIMS; ION-TOF GmbH TOF-SIMS5) device.

The ToF-SIMS device was operated through a 30 keV Bi³⁺ analysis beam (having an analysis region of 100×100 μm²) and a 1 keV Cs⁺ sputter beam (having a raster region of 300*300 μm²) in the raster region.

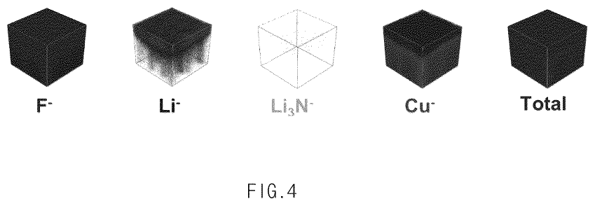

FIG. 4 is a 3D cubic image obtained by analyzing an electrode surface according to Embodiment 2 using TOF-SIMS.

Referring to FIG. 4, it was recognized that the lithium fluoride layer was formed by sufficiently supplying fluorine onto the electrode surface.

### Experimental Example 2—Evaluation of Ammonia Synthesis Efficiency

The ammonia synthesis efficiency was evaluated by calculating the Faraday efficiency, and the Faraday efficiency (FE) was calculated through following Equation 1, and showed in following Table 1.

$$FE = ( 3 \cdot F \cdot C \cdot V ) / Q \qquad 〈 Equation 1 〉$$

In this case, ‘F’ refers to a Faraday constant (1F=96,485 C/mol), ‘C’ refers to the total concentration of ammonia determined by NMR, ‘V’ refers to the volume of the electrolyte after the reaction, and ‘Q’ refers to the total charge transferred to an electrochemical cell.

The concentration of ammonia was determined by analyzing ¹H NMR by measuring with a Nuclear Magnetic Resonance (NMR) instrument (Bruker NMR 500 MHz spectrometer; Avance III).

TABLE 1

| Classification | Faraday efficiency (%) |
|---|---|
| Embodiment 6 | 73.9 |
| Embodiment 7 | 82.2 |
| Embodiment 8 | 75.0 |
| Embodiment 9 | 73.1 |
| Embodiment 10 | 76.5 |
| Comparative Example 5 | 67.5 |
| Comparative Example 6 | 67.9 |
| Comparative Example 7 | 69.2 |
| Comparative Example 8 | 67.9 |

Referring to Table 1, Embodiments 6 to 10 utilizing LiBF₄ or LiPF₆ as the first lithium salt for providing fluorine ions (F—) showed higher Faraday efficiency, such that excellent ammonia synthesis efficiency was showed. However, according to Comparative Examples 5 to 8, in which the first lithium salt is not added or LiClO₄ or LiBO_{B} serves as the first lithium salt, lower Faraday efficiency is showed, such that degraded ammonia synthesis is showed.

In addition, it was recognized that higher Faraday efficiency according to Embodiment 7 utilizing 0.3 wt % of LiBF₄ serving as the first lithium salt was showed, as compared to embodiment 6 employing 0.1 wt % of LiBF₄ serving as the first lithium salt and Embodiment 8 utilizing 0.5 wt % of LiBF₄ serving as the first lithium salt.

TABLE 2

| Classification | Faraday efficiency (%) |
|---|---|
| Embodiment 11 | 60.1 |
| Embodiment 12 | 69.7 |
| Comparative Example 9 | 43.6 |

Furthermore, referring to Table 2, it was recognized that the electrochemical nitrogen reduction reaction was performed to implement higher ammonia synthesis efficiency, even if the electrochemical nitrogen reduction reaction was performed for a long time of four hours, when LiBF₄ serves as the first lithium salt, according to Embodiments 11 and 12 showing higher Faraday efficiency and Comparative example 9 showing remarkably lower Faraday efficiency.

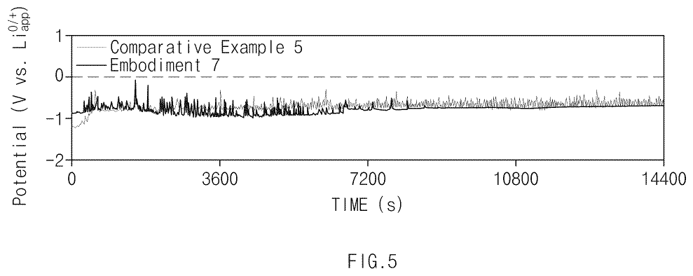

Meanwhile, FIG. 5 is a graph illustrating the change in the potential of a reduction electrode according to reaction time. Referring to FIG. 5, the reduction electrode shows a smaller change in potential in Embodiment 7 using 0.3 wt % of LiBF₄ serving as the first lithium salt than Comparative Example 5 in which the first lithium salt was not added. Accordingly, it was recognized that the stabler electrochemical nitrogen reduction reaction may be performed in embodiment 7.

As described above, according to an embodiment of the present disclosure, in the electrolyte for the electrochemical nitrogen reduction reaction and the method for electrochemically preparing ammonia using the same, ammonia synthesis yield may be improved by increasing reaction selectivity for the ammonia, and reaction stability may be maintained excellently even in the operation for a long time.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An electrolyte for an electrochemical nitrogen reduction reaction, the electrolyte comprising:
a first lithium salt including at least one selected from the group consisting of a fluoroborate-based lithium salt, a fluorophosphate-based lithium salt, a fluoroarcenate-based lithium salt, and a fluorosulfonylimide-based lithium salt;
a second lithium salt different from the first lithium salt; and an organic solvent.

2. The electrolyte of claim 1, wherein the first lithium salt includes at least one selected from the group consisting of LiBF₄₋ₓHₓ, LiPF_{6-y}H_{y}, LiAsF_{6-y}H_{y}, LiDFOB (Lithium bis(2,2-difluoro-1,3-dioxolane-4,5-bis (oxalato)borate), LiFSI (Lithium bis(fluorosulfonyl)imide), LiFOB (Lithium difluoro (oxalato)borate), and Li⁽⁺⁾ F—SO₂—N(−) SO₂—R (in which ‘x’ denotes a real number ranging from 0 to 3, ‘y’ and ‘z’ denote each independently a real number ranging from 0 to 5, and ‘R’ denotes an alkyl group or a fluoroalkyl group having 1 to 6 carbon atoms).

3. The electrolyte of claim 1, wherein the first lithium salt includes at least one selected from the group consisting of LiBF₄, LiPF₆, LiAsF₆, and an mixture of LiBF₄, LiPF₆, and LiAsF₆.

4. The electrolyte of claim 1, wherein the first lithium salt is contained in an amount of 0.0001 wt % to 10 wt %.

5. The electrolyte of claim 1, wherein the organic solvent includes at least one selected from the group consisting of propylene carbonate, ethylene carbonate, dimethyl carbonate, 1,3-dioxolane, dimethoxyethane, tetrahydrofuran, dimethylformamide, acetonitrile, N-methylpyrrolidone, ethanol, 1-propanol, 2-methyl-1-propanol, tert-butyl alcohol, 2-butanol, 2-ethyl-1-butanol, 1-pentanol, 1-hexanol, 1-heptanol, 1-nonanol, benzyl alcohol, phenol, 1-phenylethanol, 2-phenylethanol, 2-chloroethanol, 2,2,2-trifluoroethanol, hexafluoro 2-propanol, 1,3-butanediol, glycerol, triethylene glycol, 1,5-pentanediol, acetic acid, hexane, alkyl alcohol, 2-methoxyethanol, 1-propanediol, methanol, cyclohexanol, 3-butene-1-ol, 2-propanol, 1-butanol, 3-methyl-1-butanol, and a mixture of propylene carbonate, ethylene carbonate, dimethyl carbonate, 1,3-dioxolane, dimethoxyethane, tetrahydrofuran, dimethylformamide, acetonitrile, N-methylpyrrolidone, ethanol, 1-propanol, 2-methyl-1-propanol, tert-butyl alcohol, 2-butanol, 2-ethyl-1-butanol, 1-pentanol, 1-hexanol, 1-heptanol, 1-nonanol, benzyl alcohol, phenol, 1-phenylethanol, 2-phenylethanol, 2-chloroethanol, 2,2,2-trifluoroethanol, hexafluoro 2-propanol, 1,3-butanediol, glycerol, triethylene glycol, 1,5-pentanediol, acetic acid, hexane, alkyl alcohol, 2-methoxyethanol, 1-propanediol, methanol, cyclohexanol, 3-butene-1-ol, 2-propanol, 1-butanol, 3-methyl-1-butanol.

6. The electrolyte of claim 1, wherein the second lithium includes at least one selected from the group consisting of lithium perchlorate, lithium dithionate, lithium sulfate, lithium bromide, lithium chloride, lithium bis(oxalato)borate, and a mixture of lithium perchlorate, lithium dithionate, lithium sulfate, lithium bromide, lithium chloride, lithium bis(oxalato)borate.

7. A method for electrochemically preparing ammonia, the method comprising:
synthesizing the ammonia from nitrogen (N₂) through an electrochemical nitrogen reduction reaction, by applying a current to a reduction electrode under presence of the electrolyte for the electrochemical nitrogen reduction reaction according to claim 1.

8. The method of claim 7, wherein a layer including lithium fluoride including fluorine ions (F⁻) provided from the first lithium salt is formed on a surface of the reduction electrode by applying the current to the reduction electrode.

9. The method of claim 7, wherein the applying of the current to the reduction electrode includes:
applying the current to the reduction electrode in a range of −1 mA/cm² to −100 mA/cm² for 15 minutes to 12 hours.

10. The method of claim 7, wherein the reduction electrode includes:
at least one selected from the group consisting of gold (Au), silver (Ag), copper (Cu), platinum (Pt), zinc (Zn), iron (Fe), titanium (Ti), tin (Sn), indium (In), bismuth (Bi), samarium (Sm), nickel (Ni), molybdenum (Mo), cobalt (Co), stainless steel, graphene, carbon nanotubes, and fullerene.

11. The method of claim 7, wherein the nitrogen (N₂) reacts with lithium provided from the first lithium salt and the second lithium salt to form lithium nitride (LiₓN), in which ‘x’, which is the subscript of Li, denotes a molar ratio of Li element, is a real number of at least ‘1’.

12. The method of claim 11, wherein the lithium nitride (LiₓN) binding with the layer including the lithium fluoride reacts with hydrogen ions (H⁺) to synthesize ammonia (NH₃).
